(19) United States
(12) Patent Application Publication
(10) Pub. No.: US 2007/0271407 A1
(43) Pub. Date: Nov. 22, 2007

(54) DATA ACCESSING METHOD AND SYSTEM FOR PROCESSING UNIT

(75) Inventors: Chang-Cheng Yap, Hsinchu (TW); Shih-Jen Chuang, Hsinchu (TW)

Correspondence Address: WPAT, PC, 7225 BEVERLY ST., ANNANDALE, VA, 22003, US

(73) Assignee: RDC SEMICONDUCTOR CO., LTD., Hsinchu (TW)

(21) Appl. No.: 11/834,718

(22) Filed: Aug. 7, 2007

Related U.S. Application Data
(63) Continuation-in-part of application No. 10/830,592, filed on Apr. 22, 2004.

(30) Foreign Application Priority Data
Aug. 29, 2003 (TW) 092123880

(51) Int. Cl. G06F 13/36

(52) U.S. Cl. 710/315

(57) ABSTRACT

A data accessing method executed by a processing unit, the method comprising the steps of: (a) decoding an instruction; (b) checking whether the instruction has to be repeated M times to read data with successive addresses in a main memory, wherein the number M is stored in a count register of the processing unit; (c) if the step (b) is true, getting a data from a cache, a pre-fetch buffer, or the main memory, and then decreasing M by one; (d) if M is zero, terminating the data accessing method; (e) determining and pre-fetching data by comparing M to the number of unread data stored in the cache and the pre-fetch buffer; and (f) getting the next data from the cache or the pre-fetch buffer, decreasing M by one, and then returning to step (d).

### CROSS REFERENCE TO RELATED PATENT APPLICATION

This patent application is a continuation-in-part (CIP) application of a U.S. patent application Ser. No. 10/830,592 filed on Apr. 22, 2004 and now pending, and which claims the foreign priority of a Taiwan patent application Serial No. 092123880 filed Aug. 29, 2003. The contents of the related patent application are incorporated herein for reference.

### FIELD OF THE INVENTION

The present invention relates to data accessing methods and systems, and more particularly, to a data accessing method and system implemented by a processing unit.

### BACKGROUND OF THE INVENTION

High-performance data processing devices are currently under increasing demand; the most indispensable one among them is the processing unit. For example, the central processing unit (CPU) on a personal computer provides functions of decoding and executing instructions (commands), and transmitting and receiving data from other data sources via a data transmission path, such as a bus. In order to achieve high performance, the Intel® i486 (or products with similar level manufactured by other processing unit manufacturers) or other high-end processing unit mostly includes a L1 cache and/or L2 cache. Cache usually exists between the CPU and main memory (DRAM), and the cache usually consists of a static random access memory (SRAM). When the CPU wishes to read data, the CPU will first check the data stored in the internal cache. If the internal cache does not have the desired data, the CPU then will check the data stored in the external cache. If the external cache still does not have the desired data, the CPU then will issue the memory controller a read request to read the desired data from the main memory.

In order to increase system performance, a conditional data pre-fetching in a device controller is disclosed by the U.S. Pat. No. 5,761,718. In this patent, a memory controller (north bridge), located between the CPU and the main memory (DRAM), determines whether it should pre-fetch data from main memory by analyzing CPU signals including ADS_, W_R, D_C, M_IO signals. When CPU repeatedly accesses a large amount of data with successive addresses in the main memory, the memory controller determines that the CPU is performing a burst MEMR, a MEMW or an IOW in accordance of the above signals. Once the memory controller determines that the CPU is accessing data with successive addresses, the memory controller predicts CPU's next requested data and pre-fetches the predicted data from the main memory (DRAM).

Some commands in the X86's instruction set including REP MOVS, REP SCAS, and REP OUTS will repeatedly read data with successive addresses. The following contents describe the accessing steps of the CPU, wherein clength is bytes of one cache line and Ainc means an address increment.

```
1. REP MOVS :
  if data is in cacheable region and MEMW hit cache then
      burst MEMR address A0
      burst MEMR address A0+clength ( or A0−clength )
      burst MEMR address A0+2*clength ( or A0−2*clength )
      ... ( other actions )
  else if data is in cacheable region but MEMW not hit cache
      burst MEMR address A0
      repeat MEMW N times
      burst MEMR address A0+clength ( or A0−clength )
      repeat MEMW N times
      burst MEMR address A0+2*clength ( or A0−2*clength )
      ... ( other actions )
  else if data is in non-cacheable region
      MEMR address A0
      MEMW
      MEMR address A0+Ainc ( or A0−Ainc )
      MEMW
      MEMR address A0+2*Ainc ( or A0−2*Ainc )
      MEMW
      ... ( other actions )
2. REP SCAS :
  if data is cacheable
      burst MEMR address A0
      burst MEMR address A0+clength ( or A0−clength )
      burst MEMR address A0+2*clength ( or A0−2*clength )
      ... ( other actions )
  else if data is non-cacheable
      MEMR address A0
      MEMR address A0+Ainc ( or A0−Ainc )
      MEMR address A0+2*Ainc ( or A0−2*Ainc )
      ... ( other actions )
3. REP OUTS :
  if data is cacheable
      burst MEMR address A0
      repeat IOW N times
      burst MEMR address A0+clength ( or A0−clength )
      repeat IOW N times
      burst MEMR address A0+2*clength ( or A0−2*clength )
      ... ( other actions )
  else if data is non-cacheable
      MEMR address A0
      IOW
      MEMR address A0+Ainc ( or A0−Ainc )
      IOW
      MEMR address A0+2*Ainc ( or A0−2*Ainc )
      IOW
      ... ( other actions )
```

When caching the data, according to the REP MOVS command, the CPU repeatedly issues a burst MEMR with address A1, and then issues a burst MEMR with address A1+clength, and then issues a burst MEMR with address A1+*2clength, and so on. According to the REP SCAS command, the CPU repeatedly issues a burst MEMR with address A1, and then issues a burst MEMR with address A1+clength, and then issues a burst MEMR with address A1+*2clength, and so on. According to the REP OUTS command, the CPU repeatedly issues a burst MEMR with address A1, and then issues N times of IOW, and then issues a burst MEMR with address A1+clength, and then issues N times of IOW, and so on. The number of repetition is determined by the value stored in the CX register (count register).

As shown in FIG. 1 of the U.S. Pat. No. 5,761,718, the memory controller analyzes CPU's command signals mentioned above and determines that the CPU is executing one of the above commands and reading data from the main memory (DRAM) with successive addresses. When the memory controller determines that the CPU issues a first burst MEMR with address A1 and a second burst MEMR with address A1+32 (with or without repeating N times MEMW or IOW), the memory controller predicts that the next desired data is at the main memory address A1+64. The memory then will pre-fetch the predicted data at the address A1+64. This conditional data pre-fetching method enhances the system performance by eliminating the wait state while executing successive memory reads.

As known in the art, the CPU and the memory controller are two separated devices in a computer system. The memory controller predicts and pre-fetches desired data from the main memory according to the burst MEMR issued by the CPU. Because the program instructions are decoded inside the CPU, the memory controller cannot know what the next instruction will be. Therefore, if the CPU issues the last burst MEMR to the memory controller, the memory controller inevitably will pre-fetch the next predicted data even the next data will never been accessed by the CPU. Thus, it would decrease the system performance by pre-fetching the unwanted data. That is to say, the data pre-fetching mechanism built in the memory controller cannot guarantee that the pre-fetched data to be accessed by the CPU.

### SUMMARY OF THE INVENTION

In order to solve the problem of the prior art, a primary objective of the present invention is to provide a data accessing method and system for a processing unit. When CPU decodes the commands for repeatedly accessing data with successive addresses, the CPU itself will determine whether to pre-fetch the next data by checking the remaining number of repetition, the data in the cache, and the data in the pre-fetch buffer, wherein the pre-fetch buffer can be constructed within the CPU, memory controller, or independently. Thereby, it guarantees that the pre-fetched data will be accessed by the CPU.

The present invention provides a data accessing method for used in a CPU comprising the steps of: (a) decoding an instruction; (b) checking whether the instruction is repeated M times to read data with successive addresses in a main memory, wherein the number M is stored in a count register of the processing unit; (c) if the step (b) is true, getting a data from a cache, a pre-fetch buffer, or the main memory, and decreasing the number M stored in the counter register by one; (d) if M is zero, terminating the data accessing method; (e) determining and pre-fetching data by comparing M to the number of unread data stored in the cache and the pre-fetch buffer; and (f) getting the next data from the cache or the pre-fetch buffer, decreasing M by one, and then returning to step (d).

The present invention further provides a data accessing method for use in a processing unit, the method comprising the steps of: decoding an instruction; checking whether the instruction has to read an amount of data with successive addresses from a main memory; and, pre-fetching a portion of the amount of data into a pre-fetch buffer in the processing unit before the portion the amount of data being read by the processing unit.

Compared to the conventional data accessing system and method, the data accessing method and system of the present invention provides the benefit of reducing waiting state for data fetching, and furthermore it obtains the full prediction on the data to be subsequently read by the processing unit.

### BRIEF DESCRIPTION OF THE DRAWINGS

A better understanding of the present invention can be obtained when the forgoing detailed description is considered in conjunction with the following drawings, in which:

FIG. 1 is a flowchart showing a conventional pre-fetching method executed by a memory controller; and

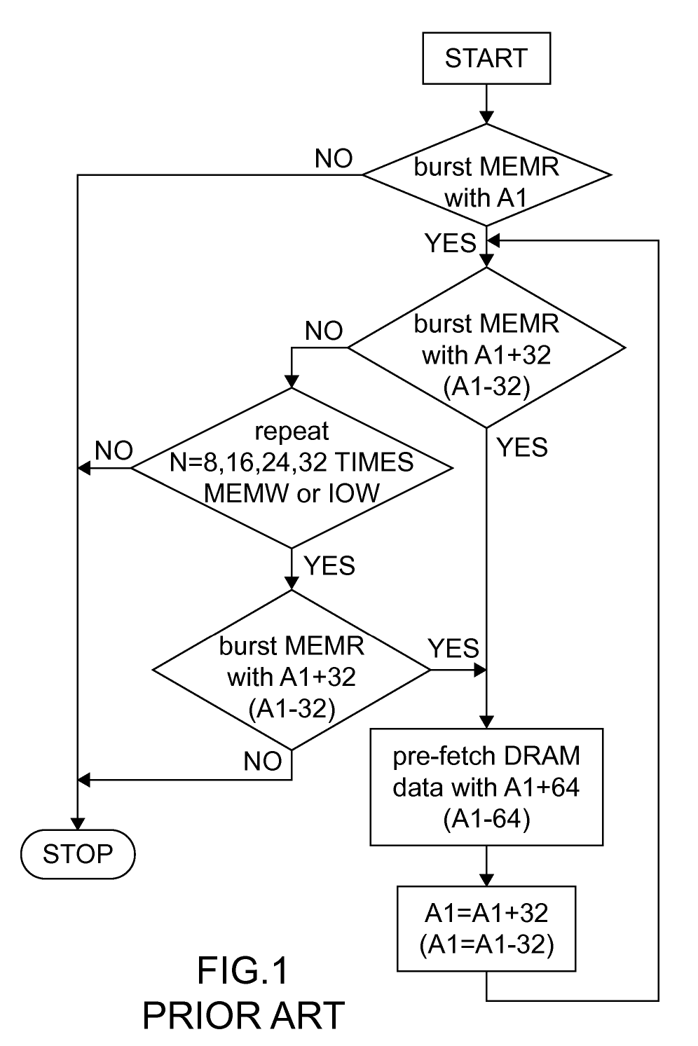

FIG. 2 is a flowchart showing the present inventive pre-fetching method executed by a processing unit.

### DETAILED DESCRIPTION OF THE PREFERRED EMBODIMENT

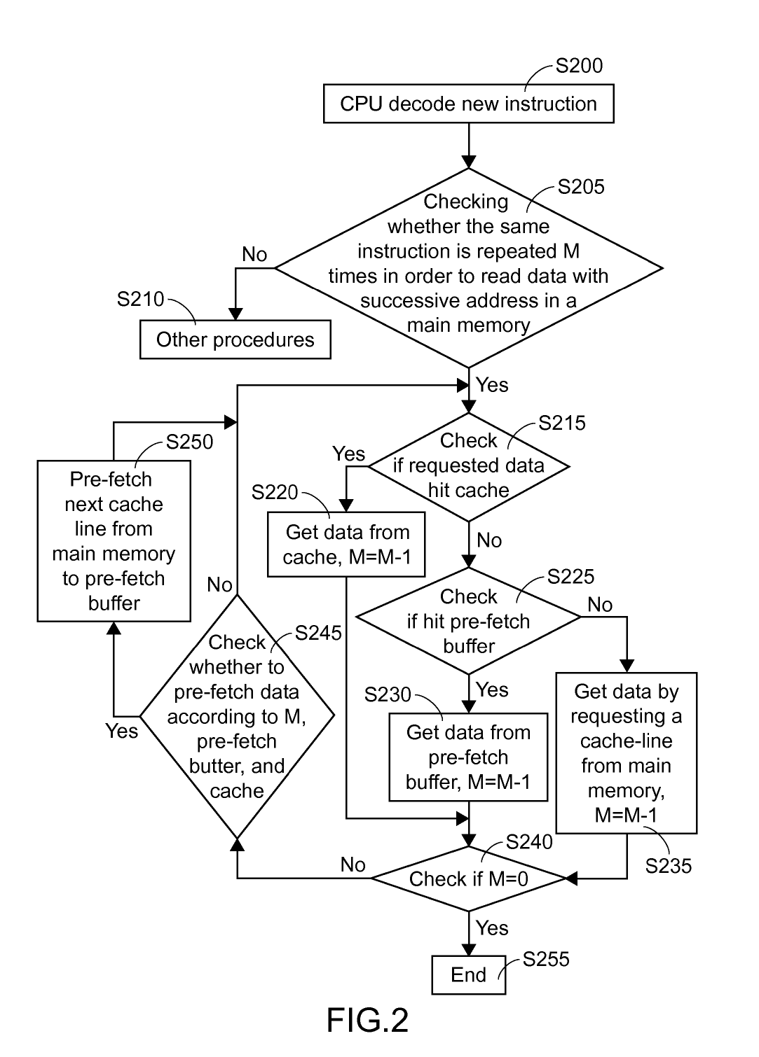

As known in the art, some instructions including REP MOVS, REP SCAS, and REP OUTS have to repeatedly read data with successive addresses. The amount of the continuous data is determined by the CX (count register). FIG. 2 shows a flow diagram of present invention to pre-fetch data by processing unit (CPU). When CPU decodes an instruction (S200), the CPU has to check whether the instruction has to read an amount of data with successive addresses in the main memory or not (S205). If it is not true, then the CPU will not apply the pre-fetching logic and execute decoded procedure (S210). If the instruction is determined to access the amount of data with successive addresses, for example REP MOVS, REP SCAS, REP OUTS, or REP CMPS, and so on, the CPU will start to read the desired data from the cache, pre-fetch buffer, or the main memory M times, wherein the number M is the value stored in the CX.

When the CPU starts to read the desired data, CPU checks whether the cache has the desired data (S215). If the cache does have the desired data (cache hit), the CPU then directly gets the desired data from the cache and decreases the M value in the CX by one (S220). If cache does not have the desired data (cache miss), the CPU checks whether the pre-fetch buffer has the desired data (S225). If the pre-fetch buffer has the desired data (pre-fetch buffer hit), the CPU then directly gets the desired data from the pre-fetch buffer and decreases the M value in the CX by one (S230). Otherwise, the CPU issues a burst MEMR command to the main memory for reading the desired data by fetching a full cache-line data into the cache (for example, 32 bytes), then decreases the M value stored in the CX by one (S235).

Each time when the CPU decreases the M value by 1, the CPU checks whether the M value is equal to zero (S240). If the M value is equal to zero, the execution of the instruction is completed (S255). Otherwise, the CPU would have to read the data stored at the next address. Before reading the next data, the CPU has to check whether to pre-fetch the data according to M, cache, and pre-fetch buffer.(S245).

For example, if an amount of remaining data stored in the cache and the pre-fetch buffer is more than M, that means the remaining data stored in the cache and the pre-fetch buffer contain all the data for completing CPU's request; the CPU then does not need to fetch additional data in S245. If an amount of remaining data stored in the cache and the pre-fetch buffer is less than M, that means there are additional data in the main memory which CPU will want to access. At this time, the CPU will pre-fetch the next cache line from main memory to pre-fetch buffer in S245 if pre-fetch buffer has free space to accommodate a cache line.

If an amount of remaining data stored in the cache or the pre-fetch buffer is sufficient to complete CPU's request, the CPU does not pre-fetch the next cache line and then goes back to step S215 or S225 to read the next desired data. If an amount of remaining data stored in the cache or the pre-fetch buffer cannot complete CPU's request, the CPU will pre-fetch the next cache line from main memory to pre-fetch buffer (S250) and read the next desired data at step S215 or S225.

According to the present invention, the CPU can accurately pre-fetch the desired data by checking the count register (CX), an amount of remaining data stored in the cache and the pre-fetch buffer. When the pre-fetch action is executed by the CPU, it guarantees that the next desired data will be found in the pre-fetch buffer and data pre-fetching will only be carried out when it is necessary. That is to say, the CPU pre-fetching performance will be higher than the memory controller pre-fetching performance disclosed in the prior art by eliminating the un-necessary data pre-fetching.

According to the above, when the CPU decodes a command for repeatedly reading data located at successive addresses, the CPU can accurately predict the necessity of data pre-fetching and send the next pre-fetching request in advance to the main memory, which will be used in the subsequent read cycle of the CPU, thereby obtaining the objective of eliminating waiting time for fetching from the main memory.

In summary, the processing unit data accessing method and system of the present invention not only eliminate the time that the processing unit has to wait for data accessing, the present invention also achieves a full prediction of the subsequent data to be read by the processing unit.

The above embodiments are only to illustrate, not limit, the principles and results of the present invention. Any person with ordinary skill in the art can make modifications and changes to the above embodiments, yet still within the scope and spirit of the present invention. Thus, the protection boundary sought by the present invention should be defined by the following claims.

What is claimed is:

1. A data accessing method for used in a processing unit, the method comprising the steps of:
(a) decoding an instruction;
(b) checking whether the instruction is repeated M times to read data with successive addresses in a main memory, wherein M is stored in a count register of the processing unit;
(c) if the step (b) is true, getting a data from a cache, a pre-fetch buffer, or the main memory, and then decreasing M by one;
(d) if M is zero, terminating the data accessing method;
(e) determining and pre-fetching data by comparing M to the number of unread data stored in the cache and the pre-fetch buffer; and
(f) getting the next data from the cache or the pre-fetch buffer, decreasing M by one, and then returning to step (d).

2. The method as claimed in claim 1, wherein the instruction includes REP MOVS, REP SCAS, REP OUTS, or REP CMPS.

3. The method as claimed in claim 1, wherein the step (c) comprises steps of:
(c1) getting the data from the cache if the data is stored in the cache;
(c2) getting the data from the pre-fetch buffer if the data is stored in the pre-fetch buffer; and
(c3) getting the data by issuing a burst MEMR to the main memory for getting a cache line including the data.

4. A data accessing method for use in a processing unit, the method comprising the steps of:
decoding an instruction;
checking whether the instruction has to read an amount of data with successive addresses from a main memory; and
pre-fetching a portion of the amount of data into a pre-fetch buffer before the portion the amount of data being read by the processing unit.

5. The method as claimed in claim 4, wherein the instruction includes REP MOVS, REP SCAS, REP OUTS, or REP CMPS.

6. The method as claimed in claim 4, wherein the processing unit has to read the amount of data with successive addresses by repeating M times of the instruction, and the number M is stored in a count register of the processing unit.
